(19) United States
(12) Patent Application Publication
(10) Pub. No.: US 2024/0265579 A1
(43) Pub. Date: Aug. 8, 2024

(54) ELECTRONIC DEVICE, PARAMETER CALIBRATION METHOD, AND NON-TRANSITORY COMPUTER READABLE STORAGE MEDIUM

(71) Applicant: HTC Corporation, Taoyuan City (TW)

(72) Inventor: Chunkai HUANG, Taoyuan City (TW)

(21) Appl. No.: 18/432,065

(22) Filed: Feb. 5, 2024

Related U.S. Application Data
(60) Provisional application No. 63/483,760, filed on Feb. 8, 2023.

(51) Int. Cl. G06T 7/80; H04N 17/00

(52) U.S. Cl. CPC G06T 7/80; H04N 17/002; G06T 2207/30244

(57) ABSTRACT

An electronic device is disclosed. The electronic device includes a memory, several cameras, and a processor. The memory is configured to store a SLAM module. The several cameras are configured to capture several images of a real space. The processor is configured to: process the SLAM module to establish an environment coordinate system in correspondence to the real space and to track a device pose of the electronic device within the environment coordinate system according to several images; and perform a calibration process. The operation of performing the calibration process includes: calculating several poses of several cameras within the environment coordinate system according to several light spots within each of several images, in which several light spots are generated by a structured light generation device; and calibrating several extrinsic parameters between several cameras according to several poses.

### CROSS-REFERENCE TO RELATED APPLICATION

This application claims priority to U.S. Provisional Application Ser. No. 63/483,760, filed Feb. 8, 2023, which is herein incorporated by reference.

### BACKGROUND

### Field of Invention

The present application relates to an electronic device, a parameter calibration method, and a non-transitory computer readable storage medium. More particularly, the present application relates to an electronic device, a parameter calibration method, and a non-transitory computer readable storage medium with a SLAM module.

### Description of Related Art

Self-tracking devices, such as VR headsets or trackers, access a SLAM module to determine their positions in the real space with the images captured by the cameras within the self-tracking devices. However, changes in the self-tracking devices, such as damage or breakage during deliver or usage, can affect the relative position and the relation rotation between the cameras of the self-tracking devices, and the pre-set extrinsic parameters, including the pre-set relative position parameter and the pre-set relative rotation parameter, between the cameras of the self-tracking devices may no longer be used, in which the performance of the SLAM module may be decreased.

When the changes to the cameras (such as the relative position and the relation rotation between the cameras) of the self-tracking devices become significant, the self-tracking devices may become unable to track themselves with the SLAM module even if the cameras themselves are functioning properly. Several methods are proposed to recalculate the extrinsic parameters of the cameras of the self-tracking devices, such as recalculating the extrinsic parameters with a checkerboard or a Deltille grid. However, it is impractical for the users to carry the checkerboard or the Deltille grid at any time.

Therefore, how to calibrate the extrinsic parameters between the cameras of the self-tracking device without the existence of the checkerboard or the Deltille grid is a problem to be solved.

### SUMMARY

The disclosure provides an electronic device. The electronic device includes a memory, several cameras, and a processor. The memory is configured to store a SLAM module. The several cameras are configured to capture several images of a real space. The processor is coupled to the camera and the memory. The processor is configured to: process the SLAM module to establish an environment coordinate system in correspondence to the real space and to track a device pose of the electronic device within the environment coordinate system according to several images; and perform a calibration process. The operation of performing the calibration process includes: calculating several poses of several cameras within the environment coordinate system according to several light spots within each of several images, in which several light spots are generated by a structured light generation device; and calibrating several extrinsic parameters between several cameras according to several poses.

The disclosure provides a parameter calibration method suitable for an electronic device. The parameter calibration method includes the following operations: capturing several images of a real space by several cameras; processing a SLAM module to establish an environment coordinate system in correspondence to the real space and to track a device pose of the electronic device within the environment coordinate system according to several images by a processor; and performing a calibration process by the processor. The operation of performing the calibration process includes the following operations: calculating several poses of several cameras within the environment coordinate system according to several light spots within each of several images, wherein several light spots are generated by a structured light generation device; and calibrating several extrinsic parameters between several cameras according to several poses.

The disclosure provides a non-transitory computer readable storage medium with a computer program to execute aforesaid parameter calibration method.

It is to be understood that both the foregoing general description and the following detailed description are by examples and are intended to provide further explanation of the invention as claimed.

### BRIEF DESCRIPTION OF THE DRAWINGS

Aspects of the present disclosure are best understood from the following detailed description when read with the accompanying figures. It is noted that, according to the standard practice in the industry, various features are not drawn to scale. In fact, the dimensions of the various features may be arbitrarily increased or reduced for clarity of discussion.

FIG. 1 is a schematic block diagram illustrating an electronic device in accordance with some embodiments of the present disclosure.

FIG. 2 is a schematic block diagram illustrating another electronic device in accordance with some embodiments of the present disclosure.

FIG. 3 is a schematic diagram illustrating a user operating the electronic device as illustrated in FIG. 1 in accordance with some embodiments of the present disclosure.

FIG. 4 is a schematic diagram illustrating an electronic device in accordance with some embodiments of the present disclosure.

FIG. 5 is a flowchart illustrating a parameter calibration method in accordance with some embodiments of the present disclosure.

FIG. 6 is a flow chart illustrating an operation of FIG. 5 in accordance with some embodiments of the present disclosure.

FIG. 7 is a flow chart illustrating an operation of FIG. 6 in accordance with some embodiments of the present disclosure.

FIG. 8A is a schematic diagram illustrating an image captured by an camera as illustrated in FIG. 1 and FIG. 4.

FIG. 8B is a schematic diagram illustrating an image captured by another camera as illustrated in FIG. 1 and FIG. 4.

FIG. 9 is a flow chart illustrating an operation of FIG. 6 in accordance with some embodiments of the present disclosure.

FIG. 10 is a flow chart illustrating an operation of FIG. 5 in accordance with some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

It will be understood that, in the description herein and throughout the claims that follow, although the terms “first,” “second,” etc. may be used to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, the terms “comprise” or “comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

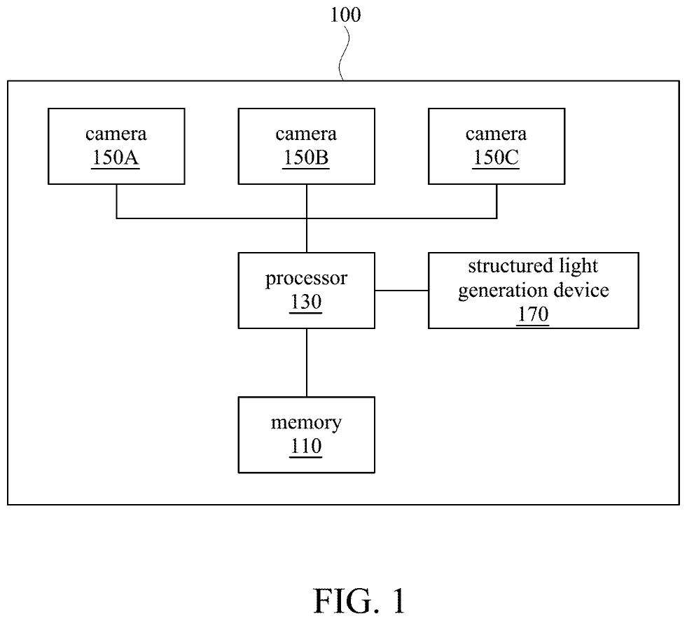

Reference is made to FIG. 1. FIG. 1 is a schematic block diagram illustrating an electronic device 100 in accordance with some embodiments of the present disclosure. As illustrated in FIG. 1, the electronic device 100 includes a memory 110, a processor 130, several cameras 150A to 150C, and a structured light generation device 170. The memory 110, the cameras 150A to 150C, and the structured light generation device 170 couple to the processor 130.

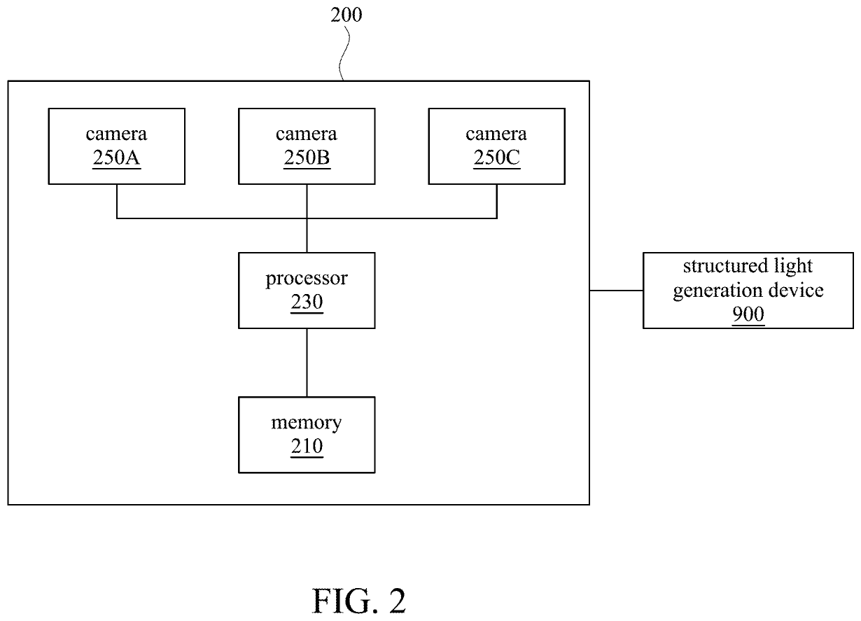

Reference is made to FIG. 2. FIG. 2 is a schematic block diagram illustrating another electronic device 200 in accordance with some embodiments of the present disclosure. As illustrated in FIG. 2, the electronic device 200 includes a memory 210, a processor 230, and several cameras 250A to 250C. The memory 210 and the cameras 250A to 250C couple to the processor 230. In some embodiments, the electronic device 200 couple to a structured light generation device 900. That is, in some embodiments, the electronic device 200 and the structured light generation device 900 are separate devices.

It should be noted that, in FIG. 1 and FIG. 2, three cameras are illustrated. However, the electronic device 100 and the electronic device 200 are for illustrative purposes only, and the embodiments of the present disclosure are not limited thereto. For example, in some embodiments, the electronic device 100 and the electronic device 200 may include two cameras, or more than three cameras. It is noted that, the embodiments shown in FIG. 1 and FIG. 2 are merely an example and not meant to limit the present disclosure.

One or more programs are stored in the memory 110 and the memory 210 and are configured to be executed by the processor 130 or the processor 230, in order to perform a parameter calibration method.

In some embodiments, the electronic device 100 and the electronic device 200 may be an HMD (head-mounted display) device, a tracking device, or any other device with self-tracking function. The HMD device may be wear on the head of a user.

In some embodiments, the memory 110 and the memory 210 store a SLAM (Simultaneous localization and mapping) module. The electronic device 100 and the electronic device 200 may be configured to process the SLAM module. The SLAM module includes functions such as image capturing, features extracting from the image, and localizing according to the extracted features. In some embodiments, the SLAM module include a SLAM algorithm, in which the processor 130 access and process the SLAM module so as to localize the electronic device 100 according to the images captured by the cameras 150A to 150C. Similarly, the processor 230 access and process the SLAM module so as to localize the electronic device 200 according to the images captured by the cameras 250A to 250C. The details of the SLAM system will not be described herein.

Specifically, in some embodiments, the electronic device 100 may be applied in a virtual reality (VR)/mixed reality (MR)/augmented reality (AR) system. For example, the electronic device 100 may be realized by, a standalone head mounted display device (HMD) or VIVE HMD.

In some embodiments, the processor 130 and 230 can be realized by, for example, one or more processing circuits, such as central processing circuits and/or micro processing circuits, but are not limited in this regard. In some embodiments, the memory 110 and 210 include one or more memory devices, each of which includes, or a plurality of which collectively include a computer readable storage medium. The non-transitory computer readable storage medium may include a read-only memory (ROM), a flash memory, a floppy disk, a hard disk, an optical disc, a flash disk, a flash drive, a tape, a database accessible from a network, and/or any storage medium with the same functionality that can be contemplated by persons of ordinary skill in the art to which this disclosure pertains.

The cameras 150A to 150C and the cameras 250A to 250C are configured to capture one or more images of the real space that the electronic device 100 and 200 are operated. In some embodiments, the cameras 150A to 150C and the cameras 250A to 250C may be realized by camera circuit devices or any other camera circuits with image capture functions.

In some embodiments, the electronic device 100 and 200 include other circuits such as a display circuit and an I/O circuit. In some embodiments, the display circuit covers a field of view of the user and shows a virtual image at the field of view of the user.

For ease of illustration, the following take the electronic device 100 as illustrated in FIG. 1 for illustrative purpose. It should be noted that the operation of the electronic device 200 as illustrated in FIG. 2 is similar to the electronic device 100 as illustrated in FIG. 1.

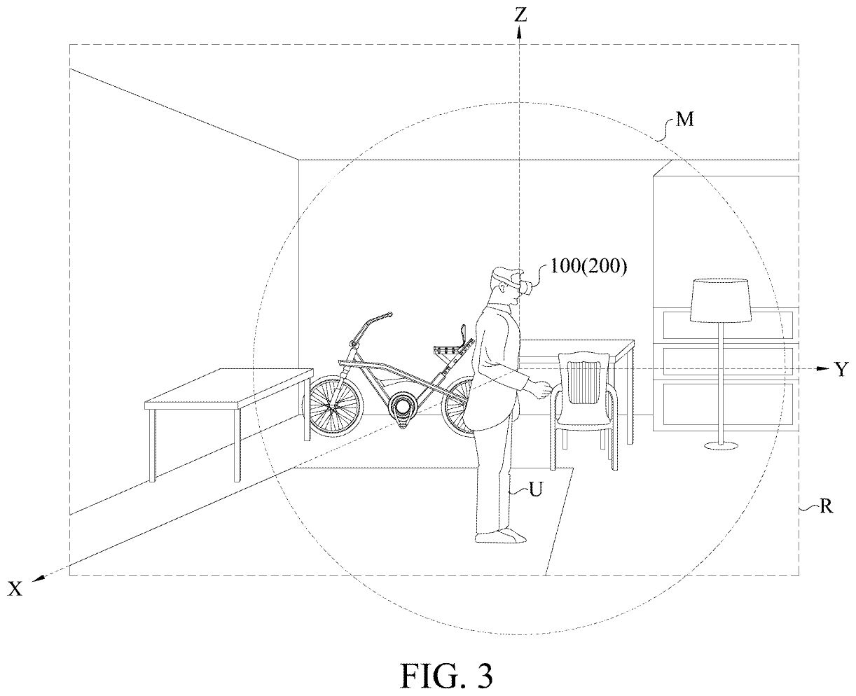

Reference is made to FIG. 3 together. FIG. 3 is a schematic diagram illustrating a user U operating the electronic device 100 as illustrated in FIG. 1 in accordance with some embodiments of the present disclosure.

As illustrated in FIG. 3, the user U is wearing the electronic device 100 as illustrated in FIG. 1 on the head of the user U. In some embodiments, the cameras 150A to 150C capture several frames of images of the real space R. The processor 130 process the SLAM module to establish a mixed reality environment coordinate system M in correspondence to the real space R according to several space feature points of the images captured by the cameras 150A to 150C. In some embodiments, the processor 130 obtains a device pose of the electronic device 100 within the mixed reality environment coordinate system M according to the feature points within the images. When the electronic device 100 moves in the real space R, the processor 130 tracks the device pose of the electronic device 100 within the mixed reality environment coordinate system M.

In other embodiments, the mixed reality environment coordinate system M could be an augmented reality environment coordinate system or an extended reality environment coordinate system. The following takes the mixed reality environment coordinate system M for examples for illustrative purposes; however, the embodiments of the present disclosure are not limited thereto.

In some embodiments, the device pose of the electronic device 100 includes a position and a rotation angle.

When calculating the device pose of the electronic device 100 according to the images captured by the cameras 150A to 150C, the intrinsic parameter and the extrinsic parameter of each of the cameras 150A to 150C are considered. In some embodiments, the extrinsic parameters represent a rigid transformation from 3D world coordinate system to the 3D camera's coordinate system. The intrinsic parameters represent a projective transformation from the 3D camera's coordinates into the 2D image coordinates. In some embodiments, the extrinsic parameters of the cameras 150A to 150C include the difference between the poses of the cameras.

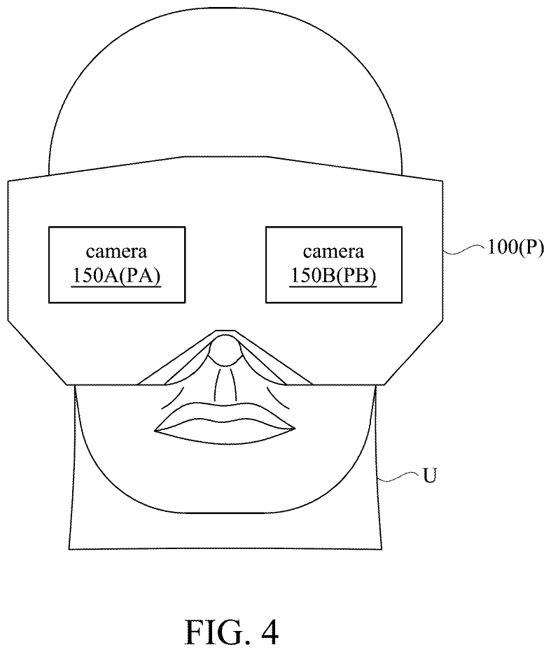

Reference is made to FIG. 4 together. FIG. 4 is a schematic diagram illustrating an electronic device 100 in accordance with some embodiments of the present disclosure. In FIG. 4, camera 150A and camera 150B of the electronic device 100 are taken as an example for illustration. In some embodiments, when the electronic device 100 is made, the positions of the camera 150A and the camera 150B and the rotation angles of the camera 150A and the camera 150B relative to the electronic device 100 is preset, and an extrinsic parameter between the camera 150A and the camera 150B is preset within the SLAM module. Similarly, the extrinsic parameters between each two of the cameras are preset within the SLAM module.

When the processor 130 tracks the device pose of the electronic device 100 within the mixed reality environment coordinate system M, the extrinsic parameters between each two of the cameras are preset within the SLAM module are considered. However, during the operation of the electronic device 100, the positions of the camera 150A and the camera 150B and the rotation angles of the camera 150A and the camera 150B relative to the electronic device 100 may be changed, and the SLAM module may no longer be working properly with the images captured by the cameras 150A and 150B and the preset extrinsic parameter between the cameras 150A and 150B. Therefore, a method for calibrating the extrinsic parameters between the cameras of the electronic device 100 is in need. In some embodiments, the extrinsic parameters are stored in the memory 110 for the processor 130 to access and operate with the SLAM module.

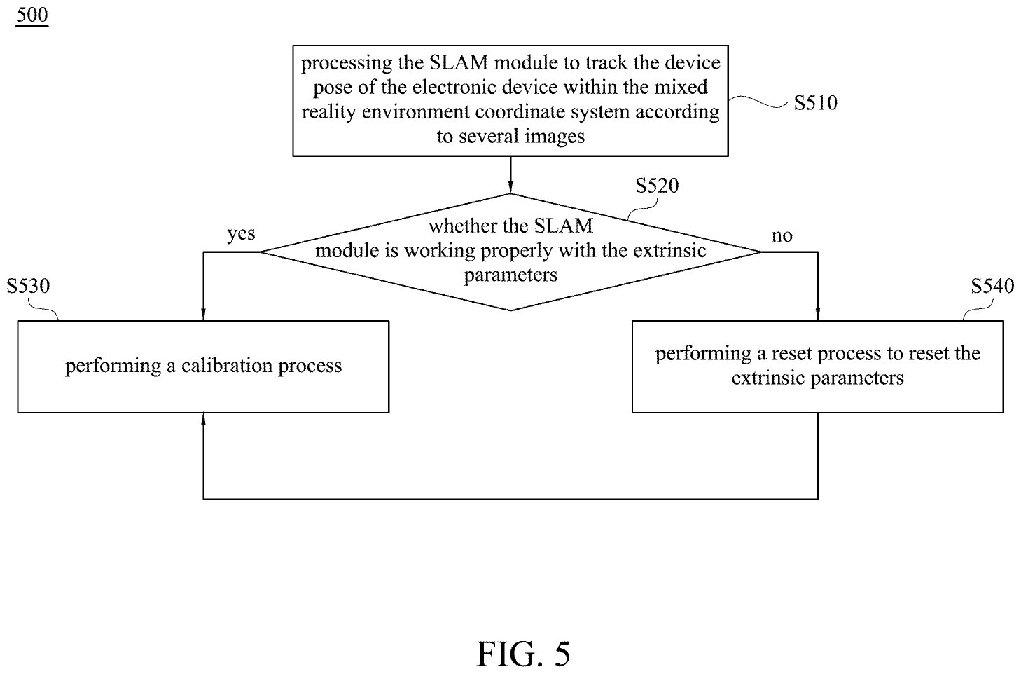

Reference is made to FIG. 5. For better understanding of the present disclosure, the detailed operation of the electronic device 100 as illustrated in FIG. 1 will be discussed in accompanying with the embodiments shown in FIG. 5. FIG. 5 is a flowchart illustrating a parameter calibration method 500 in accordance with some embodiments of the present disclosure. It should be noted that the parameter calibration method 500 can be applied to a device having a structured that is the same as or similar to the structured of the electronic device 100 shown in FIG. 1 or the electronic device 200 shown in FIG. 2. To simplify the description below, the embodiments shown in FIG. 1 will be used as an example to describe the parameter calibration method 500 in accordance with some embodiments of the present disclosure. However, the present disclosure is not limited to application to the embodiments shown in FIG. 1.

As shown in FIG. 5, the parameter calibration method 500 includes operations S510 to S540.

In operation S510, the SLAM module is processed to track the device pose of the electronic device within the mixed reality environment coordinate system according to several images. In some embodiments, the processor 130 tracks the device pose of the electronic device 100 within the mixed reality environment coordinate system M according to several space feature points within the images captured by the cameras 130A to 130C.

In operation S520, it is determined whether the SLAM module is working properly with the extrinsic parameters. In some embodiments, when the SLAM module is working properly with the extrinsic parameters stored in the memory 110, operation S530 is performed. On the other hand, when the SLAM module is not working properly with the extrinsic parameters stored in the memory 110, operation S540 is performed.

In some embodiments, the processor 130 of the electronic device 100 determines the pose of the electronic device 100 every period of time. When determining the pose of the electronic device 100, the processor 130 refers to the previous pose of the electronic device 100 determined at a previous period of time. In some embodiments, the processor 130 further refers to the positions of the space feature points determined previously when determining the pose of the electronic device 100.

When the processor 130 is unable to calculate the pose of the electronic device 100 in reference to the space feature points determined previously and/or the pose of the electronic device 100 determined at a previous period of time, it is determined that the SLAM module is not working properly with the extrinsic parameters. On the other hand, when the processor 130 is able to calculate the pose of the electronic device 100 in reference to the space feature points determined previously and/or the pose of the electronic device 100 determined at a previous period of time, it is determined that the SLAM module is working properly with the extrinsic parameters.

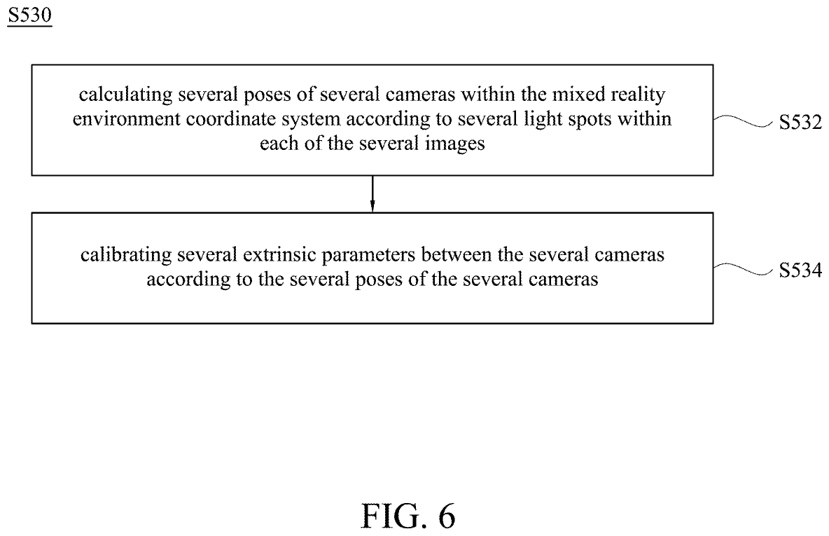

In operation S530, a calibration process is performed. Detail of the calibration process will be described in reference to FIG. 6 in the following.

Reference is made to FIG. 6 together. FIG. 6 is a flow chart illustrating operation S530 of FIG. 5 in accordance with some embodiments of the present disclosure. As illustrated in FIG. 6, the operation S530 includes operations S532 to S534.

In operation S532, several poses of several cameras are calculated within the mixed reality environment coordinate system according to several light spots within each of the several images.

In some embodiments, the light spots are generated by the structured light generation device 170 as illustrated in FIG. 1 or the structured light generation device 900 as illustrated in FIG. 2. Take the structured light generation device 170 as illustrated in FIG. 1 as an example. In some embodiments, the structured light generation device 170 generates and emits several light spots every period time.

In some embodiments, the structured light generation device 170 generates and emits several light spots with a fixed frequency. The processor 130 adjusts the exposure of each of the cameras 150A to 150C, so that the cameras 150A to 150C are able to capture the images with the light spots.

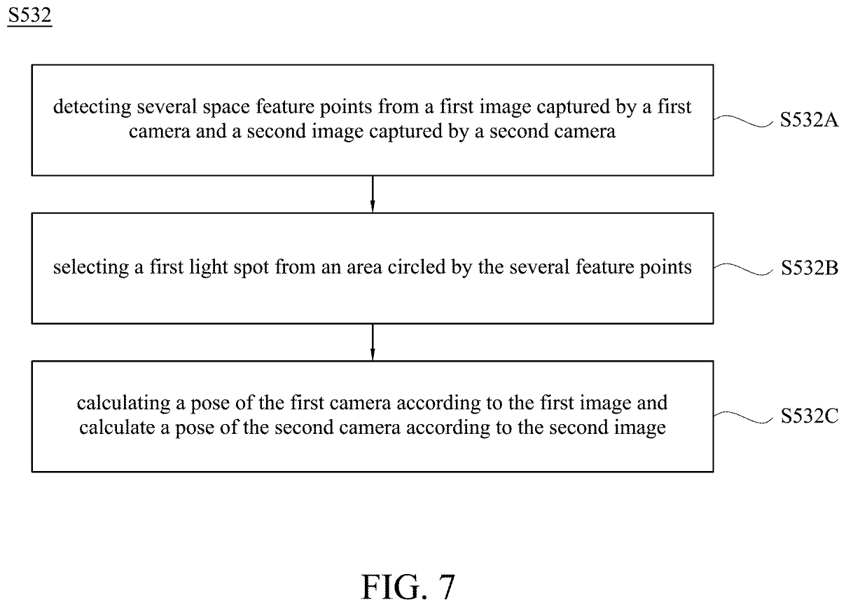

Detail of the operation S532 will be described in reference to FIG. 7 as following.

Reference is made to FIG. 7 together. FIG. 7 is a flow chart illustrating operation S532 of FIG. 6 in accordance with some embodiments of the present disclosure. As illustrated in FIG. 7, operation S532 includes operations S532A to S532C.

In operation S532A, several space feature points are detected from a first image captured by a first camera and a second image captured by a second camera.

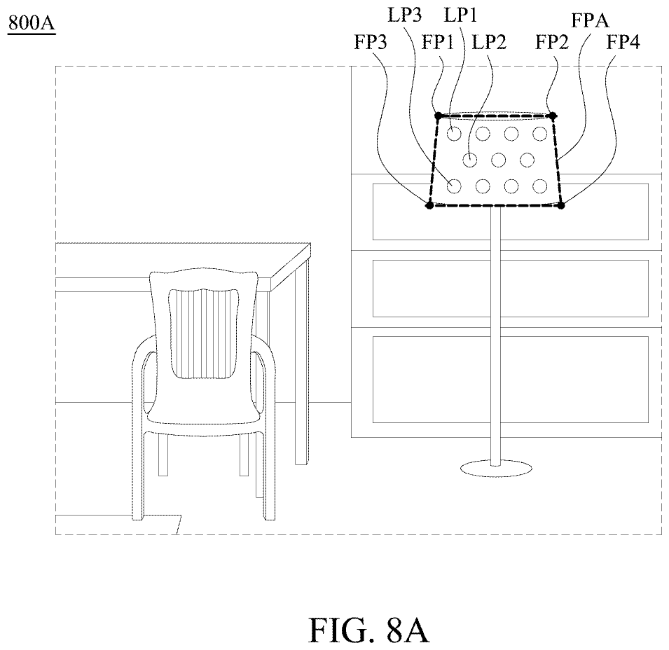

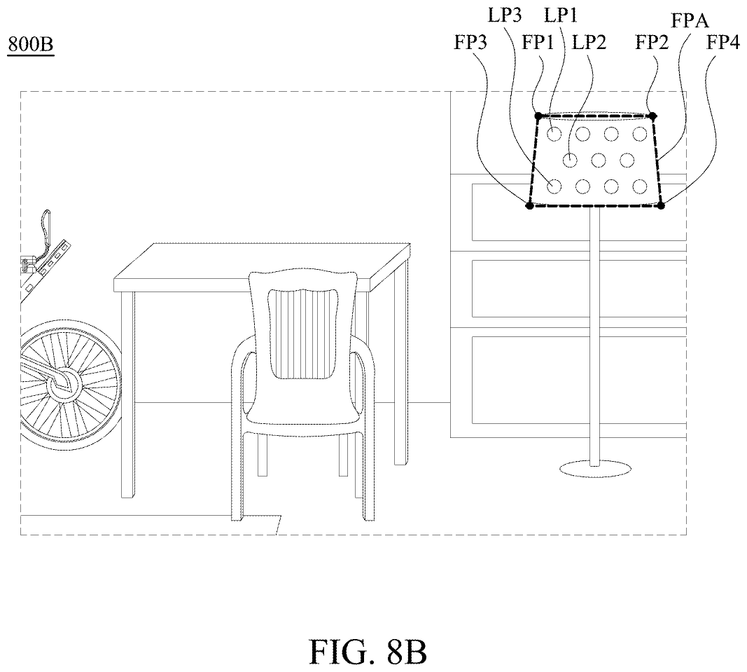

Reference is made to FIG. 8A and FIG. 8B together. FIG. 8A is a schematic diagram illustrating an image 800A captured by the camera 150A as illustrated in FIG. 1 and FIG. 4. FIG. 8B is a schematic diagram illustrating an image 800B captured by the camera 150B as illustrated in FIG. 1 and FIG. 4. It should be noted that the image 800A and the image 800B are captured with the electronic device 100 being at the same position of the mixed reality environment coordinate system M.

The processor 130 as illustrated in FIG. 1 obtains several space feature points FP1 to FP4 from the image 800A. The space feature points FP1 to FP4 are feature points of the lamp in the real space R as illustrated in FIG. 3. It should be noted that the processor 130 does not only obtain the space feature points FP1 to FP4, more space feature points may be obtained from FIG. 8A.

Similarly, the processor 130 as illustrated in FIG. 1 obtains the space feature points FP1 to FP4 from the image 800B. The space feature points FP1 to FP4 obtained from the image 800A and the space feature points FP1 to FP4 obtained from the image 800B are the same space feature points within the mixed reality environment coordinate system M. That is, the positions of the space feature points FP1 to FP4 of the image 800A within the mixed reality environment coordinate system M and the positions of the space feature points FP1 to FP4 of the image 800B within the mixed reality environment coordinate system M are the same.

Reference is made to FIG. 7 again. In operation S532B, a first light spot is selected from an area circled by the several feature points. The mixed reality environment coordinate system M may include several areas circled by at least three of the space feature points.

In some embodiments, the processor 130 selects the same area circled byte same space feature points of FIG. 8A and FIG. 8B. For example, the processor 130 selects the area FPA circled by the space feature points FP1 to FP4 in FIG. 8A and FIG. 8B. That is, the processor 130 selects the same area within the mixed reality environment coordinate system M from FIG. 8A and FIG. 8B.

After the processor 130 selects the area FPA from FIG. 8A and FIG. 8B, the processor 130 selects one of the light spots from the area FPA. Reference is made to FIG. 8A and FIG. 8B together. As illustrated in FIG. 8A and FIG. 8B, the area FPA includes several light spots LP1 to LP3. In some embodiments, in operation S532B, the processor 130 selects the light spot LP1 in FIG. 8A and FIG. 8B. In some embodiments, the processor 130 calculates the position of the light spot LP1 in the mixed reality environment coordinate system M according to the space feature points FP1 to FP4 and the images captured by the camera 150A and 150B.

In operation S532C, a pose of the first camera is calculated according to the first image and a pose of the second camera is calculated according to the second image. Reference is made to FIG. 1 and FIG. 4 together. In some embodiments, the processor 130 as illustrated in FIG. 1 calculates a pose of the camera 150A according to the light spot LP1 and the image 800A. Similarly, the processor 130 as illustrated in FIG. 1 calculates a pose of the camera 150B according to the light spot LP1 and the image 800B. That is, the processor 130 calculates the pose of the camera 150A and the pose of the camera 150B according to the position of the same light spot.

It should be noted that, in operation S532C, the pose of the camera 150A and the pose of the camera 150B may be calculated according to several light spots.

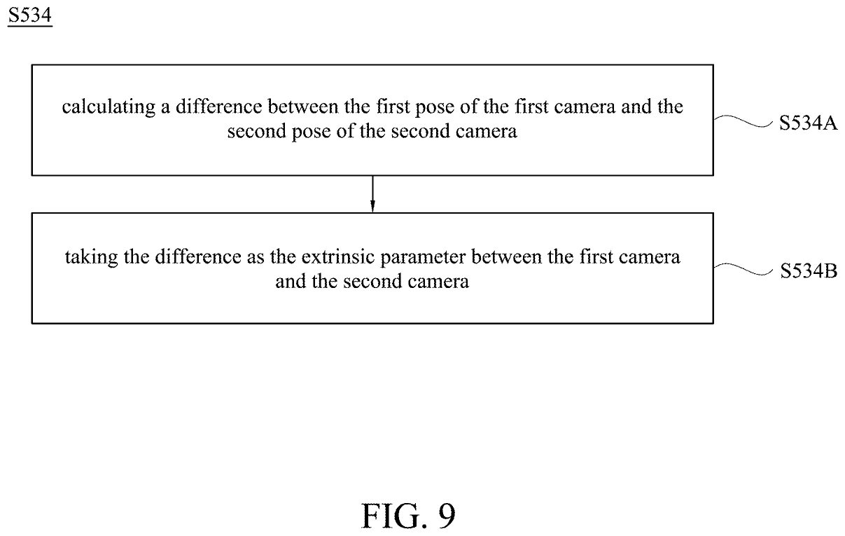

Reference is made to FIG. 6 again. In operation S534, several extrinsic parameters between the several cameras are calibrated according to the several poses of the several cameras. Detail of operation S534 will be described in the following in reference to FIG. 9.

Reference is made to FIG. 9 together. FIG. 9 is a flow chart illustrating operation S534 of FIG. 6 in accordance with some embodiments of the present disclosure. As illustrated in FIG. 9, operation S534 includes operations S534A and S534B.

In operation S534A, a difference between the first pose of the first camera and the second pose of the second camera is calculated. Reference is made to FIG. 3 and FIG. 4 together. Assume that the pose of the electronic device 100 is P during operation S530, and the pose of the camera 150A obtained in operation S532 is PA, the pose of the camera 150B obtained in operation S532 is PB, the processor 130 as illustrated in FIG. 1 calculates the difference ΔP between the pose PA and the pose PB.

Reference is made to FIG. 9 again. In operation S534B, the difference is taken as the extrinsic parameter between the first camera and the second camera. For example, in some embodiments, the processor 130 as illustrated in FIG. 1 takes the difference ΔP between the pose PA and the pose PB as the extrinsic parameter between the camera 150A and the camera 150B. In some embodiments, the processor 130 further updates the extrinsic parameter between the camera 150A and the camera 150B stored in the memory as illustrated in FIG. 1 to be the difference ΔP between the pose PA and the pose PB.

Through the operations of S530, by calculating the poses of the cameras according to the same feature points within the mixed reality environment coordinate system M, the extrinsic parameters between the cameras can be calibrated.

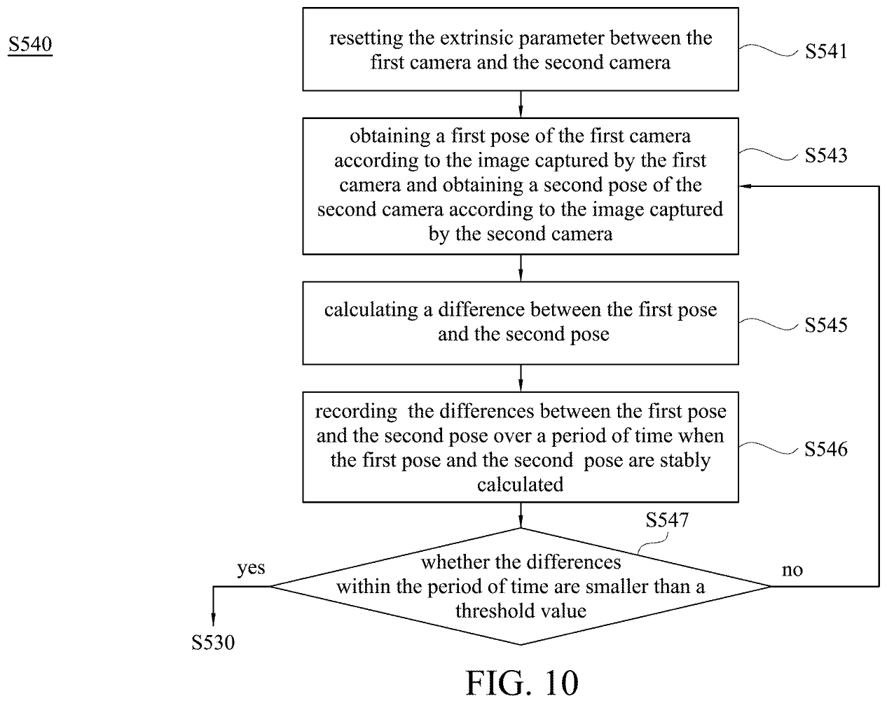

Reference is made to FIG. 5 again. In operation S540, a reset process is performed to reset the extrinsic parameters. Detail of the operation S540 will be described in reference to FIG. 10 in the following. In some embodiments, the operation S540 is performed with the electronic device 100 being static.

Reference is made to FIG. 10 together. FIG. 10 is a flow chart illustrating operation S540 of FIG. 5 in accordance with some embodiments of the present disclosure. As illustrated in FIG. 5, the operation S540 includes operations S541 to S547.

In operation S541, the extrinsic parameter between the first camera and the second camera is reset. Reference is made to FIG. 1 together. For example, the processor 130 resets the extrinsic parameter between the camera 150A and the camera 150B to be an initial value.

In operation S543, a first pose of the first camera is obtained according to the image captured by the first camera and a second pose of the second camera is obtained according to the image captured by the second camera. Reference is made to FIG. 8A and FIG. 8B together. In some embodiments, the processor 130 as illustrated in FIG. 1 obtains the pose of the camera 150A according to the space feature points of the image 800A, and the processor 130 obtains the pose of the camera 150B according to the space feature points of the image 800B. In some embodiments, the pose of the camera 150A and the pose of the camera 150B are calculated with the extrinsic parameter between the camera 150A and the camera 150B.

In operation S545, a difference between the first pose and the second pose is calculated. In some embodiments, the processor 130 as illustrated in FIG. 1 calculates a difference between the pose of the camera 150A and the pose of the camera 150B obtained in operation S543.

In operation S546, the differences between the first pose and the second pose over a period of time is recorded when the first pose and the second pose are stably calculated. In some embodiments, in operation S546, the camera 150A, the camera 150B and the processor 130 as illustrated in FIG. 1 perform operations S543 and S545 over a period of time. For example, at a first time point, the camera 150A captures a first image and the camera 150B captures a second image, and the processor 130 calculates the first pose of the camera 150A according to the first image captured at the first time point and the second pose of the camera 150B according to the second image captured at the first time point. Then, the processor 130 calculates a difference between the first pose and the second pose corresponding to the first time point. Similarly, at a second time point, the processor 130 calculates the first pose of the camera 150A according to the first image captured at the second time point and the second pose of the camera 150B according to the second image captured at the second time point. Then, the processor 130 calculates a difference between the first pose and the second pose corresponding to the second time point. In this way, the processor 130 calculates several differences of several time points within the period of time.

It should be noted that, in operation S546, the first pose and the second pose are stably calculated. In some embodiments, when the first pose and the second pose are not stably calculated, the processor 130 asks the user to change the pose of the electronic device 100. In some embodiments, the processor 130 sends a signal to the display circuit (not shown) of the electronic device 100 so as to display the signal for asking the user to change the pose of the electronic device 100. In some other embodiments, when the first pose and the second pose are not stably calculated, the processor 130 resets or adjusts the extrinsic parameter between the first camera and the second camera again.

In operation S547, it is determined whether the differences within the period of time are smaller than a threshold value. In some embodiments, the threshold value is stored in the memory 110 as illustrated in FIG. 1. In some embodiments, when all of the differences between the poses of the camera 150A and the poses of the camera 150B recorded in operation S546 are smaller than the threshold value, operation S530 as illustrated in FIG. 5 is performed. On the other hand, when it is determined that not all of the differences between the poses of the camera 150A and the poses of the camera 150B recorded in operation S546 are smaller than the threshold value, operation S543 is performed.

In some embodiments, when not all of the differences between the poses of the camera 150A and the poses of the camera 150B recorded in operation S546 are smaller than the threshold value , the extrinsic parameter between the first camera and the second camera is adjusted by the processor 130 before performing operation S543. In some embodiments, the adjustment to the extrinsic parameter includes increasing/decreasing a distance value between the camera 150A and the camera 150B. In some other embodiments, the adjustment to the extrinsic parameter includes increasing/decreasing a relative rotation value between the camera 150A and the camera 150B.

In some embodiments, after the extrinsic parameter between the camera 150A and the camera 150B is adjusted, operation S543 is performed so as to recalculate the pose of the camera 150A and the pose of the camera 150B with the adjusted extrinsic parameter between the camera 150A and the camera 150B.

In some embodiments, operations S540 is operated until all of the differences between the poses of the camera 150A and the poses of the camera 150B over the period of time are smaller than the threshold value.

The examples mentioned above takes the camera 150A and the camera 150B as illustrated in FIG. 1 and FIG. 4 for illustrative purposes so as to illustrate the detail of the operations. The operations of other cameras are similar to the operations of the cameras 150A and 150B, and will not be described in detail here.

It should be noted that, in the embodiments of the present disclosure, the pose and/or the positions of the devices and the feature points are obtained with the SLAM module.

The structured light generation devices 170 and 900 mentioned above are devices with the function of projecting a known pattern (often grids or horizontal bars) on to a scene. The way that these deform when striking surfaces allows vision systems to calculate the depth and surface information of the objects in the scene, as used in structured light 3D scanners. The embodiments of the present disclosure utilizes the function of the projecting a known pattern with light spots of the structured light generation device, so as to mimic the feature points of the chessboard or the Deltille grid, and to compensate for the problem of insufficient feature points in general environments, such as the real space R as mentioned above. By increasing the feature points, the accuracy of the calibration to the extrinsic parameters between the cameras is improved.

Through the operations of various embodiments described above, an electronic device, a parameter calibration method, and a non-transitory computer readable storage medium are implemented. The extrinsic parameters between the cameras of the self-tracking device can be calibrated with the structured light generation device, in which the deviations of the extrinsic parameters between the cameras can be corrected and the accuracy of the calibration of the extrinsic parameters between the cameras can be improved.

Furthermore, in the embodiments of the present disclosure, a chessboard or a Deltille grid is not necessary, and the users can operate the calibration process without a chessboard or a Deltille grid, which is more convenient. Moreover, by generating the spot lights at the real space R, the number of the feature points within the real space R is increased, which improves the accuracy of the calculation of the pose of the devices, and the accuracy of the calibration to the extrinsic parameters between the cameras is thereby improved.

Additionally, when critical situations occur, for example, when the SLAM module is not working properly, the embodiments of the present disclosure can perform a reset process so as to recalculate the extrinsic parameters.

It should be noted that in the operations of the abovementioned parameter calibration method 500, no particular sequence is required unless otherwise specified. Moreover, the operations may also be performed simultaneously or the execution times thereof may at least partially overlap.

Furthermore, the operations of the parameter calibration method 500 may be added to, replaced, and/or eliminated as appropriate, in accordance with various embodiments of the present disclosure.

Various functional components or blocks have been described herein. As will be appreciated by persons skilled in the art, the functional blocks will preferably be implemented through circuits (either dedicated circuits, or general purpose circuits, which operate under the control of one or more processing circuits and coded instructions), which will typically include transistors or other circuit elements that are configured in such a way as to control the operation of the circuity in accordance with the functions and operations described herein.

Although the present disclosure has been described in considerable detail with reference to certain embodiments thereof, other embodiments are possible. Therefore, the scope of the appended claims should not be limited to the description of the embodiments contained herein.

It will be apparent to those skilled in the art that various modifications and variations can be made to the structured of the present invention without departing from the scope or spirit of the invention. In view of the foregoing, it is intended that the present invention cover modifications and variations of this invention provided they fall within the scope of the following claims.

What is claimed is:

1. An electronic device, comprising:
a memory, configured to store a SLAM module;
a plurality of cameras, configured to capture a plurality of images of a real space; and
a processor, coupled to the plurality of cameras and the memory, configured to:
process the SLAM module to establish an environment coordinate system in correspondence to the real space and to track a device pose of the electronic device within the environment coordinate system according to the plurality of images; and
perform a calibration process, comprising:
calculate a plurality of poses of the plurality of cameras within the environment coordinate system according to a plurality of light spots within each of the plurality of images, wherein the plurality of light spots are generated by a structured light generation device; and
calibrate a plurality of extrinsic parameters between the plurality of cameras according to the plurality of poses.

2. The electronic device of claim 1, wherein a first camera of the plurality of cameras is configured to capture a first image of the plurality of images, and a second camera of the plurality of cameras is configured to capture a second image of the plurality of images, wherein the processor is further configured to:
calculate a first pose of the first camera according to the first image;
calculate a second pose of the second camera according to the second image;
calculate a difference between the first pose and the second pose; and
take the difference as a first extrinsic parameter between the first camera and the second camera.

3. The electronic device of claim 2, wherein the plurality of light spots comprise a first light spot, wherein both of the first image and the second image comprise the first light spot, wherein the first pose is calculated according to the first light spot within the first image, and the second pose is calculated according to the first light spot within the second image.

4. The electronic device of claim 3, wherein the processor is further configured to:
detect a plurality of space feature points from the first image and the second image; and
select the first light spot from an area circled by the plurality of space feature points.

5. The electronic device of claim 1, wherein the processor is further configured to:
determine whether the SLAM module is working properly with the plurality of extrinsic parameters;
perform the calibration process when the SLAM module is working properly; and
perform a reset process to reset the plurality of extrinsic parameters until the SLAM module is working properly with the plurality of extrinsic parameters.

6. The electronic device of claim 5, wherein the processor is further configured to:
obtain a first pose of a first camera according to a first image captured by the first camera of the plurality of cameras;
obtain a second pose of a second camera according to a second image captured by the second camera of the plurality of cameras; and
adjust a first extrinsic parameters between the first camera and the second camera until a difference between the first pose and the second pose is smaller than a threshold value.

7. The electronic device of claim 1, wherein the plurality of light spots are generated with a frequency, wherein the processor is further configured to:
adjust a plurality of exposures of the plurality of cameras so that the plurality of cameras are able to capture the plurality of images with the plurality of light spots.

8. A parameter calibration method, suitable for an electronic device, comprising:
capturing a plurality of images of a real space by a plurality of cameras;
processing a SLAM module to establish an environment coordinate system in correspondence to the real space and to track a device pose of the electronic device within the environment coordinate system according to the plurality of images by a processor; and
performing a calibration process by the processor, comprising:
calculating a plurality of poses of the plurality of cameras within the environment coordinate system according to a plurality of light spots within each of the plurality of images, wherein the plurality of light spots are generated by a structured light generation device; and
calibrating a plurality of extrinsic parameters between the plurality of cameras according to the plurality of poses.

9. The parameter calibration method of claim 8, further comprising:
capturing a first image of the plurality of images by a first camera of the plurality of cameras;
capturing a second image of the plurality of images by a second camera of the plurality of cameras;
calculating a first pose of the first camera according to the first image;
calculating a second pose of the second camera according to the second image;
calculating a difference between the first pose and the second pose; and
taking the difference as a first extrinsic parameter between the first camera and the second camera.

10. The parameter calibration method of claim 9, wherein the plurality of light spots comprise a first light spot, wherein both of the first image and the second image comprise the first light spot, the parameter calibration method further comprising:
calculating the first pose according to the first light spot within the first image, and calculating the second pose according to the first light spot within the second image.

11. The parameter calibration method of claim 10, further comprising:
detecting a plurality of space feature points from the first image and the second image; and
selecting the first light spot from an area circled by the plurality of space feature points.

12. The parameter calibration method of claim 8, further comprising:
determining whether the SLAM module is working properly with the plurality of extrinsic parameters;
performing the calibration process when the SLAM module is working properly; and
performing a reset process to reset the plurality of extrinsic parameters until the SLAM module is working properly with the plurality of extrinsic parameters.

13. The parameter calibration method of claim 12, further comprising:
obtaining a first pose of a first camera according to a first image captured by the first camera of the plurality of cameras;
obtaining a second pose of a second camera according to a second image captured by the second camera of the plurality of cameras; and
adjusting a first extrinsic parameters between the first camera and the second camera until a difference between the first pose and the second pose is smaller than a threshold value.

14. The parameter calibration method of claim 8, further comprising:
generating the plurality of light spots are generated with a frequency; and
adjusting a plurality of exposures of the plurality of cameras so that the plurality of cameras are able to capture the plurality of images with the plurality of light spots.

15. A non-transitory computer readable storage medium, wherein the non-transitory computer readable storage medium comprises one or more computer programs stored therein, and the one or more computer programs can be executed by one or more processors so as to be configured to operate a parameter calibration method, wherein the parameter calibration method comprises:
capturing a plurality of images of a real space by a plurality of cameras of an electronic device;
processing a SLAM module to establish an environment coordinate system in correspondence to the real space and to track a device pose of the electronic device within the environment coordinate system according to the plurality of images; and
performing a calibration process, comprising:
calculating a plurality of poses of the plurality of cameras within the environment coordinate system according to a plurality of light spots within each of the plurality of images, wherein the plurality of light spots are generated by a structured light generation device; and
calibrating a plurality of extrinsic parameters between the plurality of cameras according to the plurality of poses.

16. The non-transitory computer readable storage medium of claim 15, wherein the parameter calibration method further comprises:
capturing a first image of the plurality of images by a first camera of the plurality of cameras;
capturing a second image of the plurality of images by a second camera of the plurality of cameras;
calculating a first pose of the first camera according to the first image;
calculating a second pose of the second camera according to the second image;
calculating a difference between the first pose and the second pose; and
taking the difference as a first extrinsic parameter between the first camera and the second camera.

17. The non-transitory computer readable storage medium of claim 16, wherein the parameter calibration method further comprises:
calculating the first pose according to a first light spot within the first image, and calculating the second pose according to the first light spot within the second image;
wherein the plurality of light spots comprise the first light spot, wherein both of the first image and the second image comprise the first light spot.

18. The non-transitory computer readable storage medium of claim 17, wherein the parameter calibration method further comprises:
detecting a plurality of space feature points from the first image and the second image; and
selecting the first light spot from an area circled by the plurality of space feature points.

19. The non-transitory computer readable storage medium of claim 15, wherein the parameter calibration method further comprises:
determining whether the SLAM module is working properly with the plurality of extrinsic parameters;
performing the calibration process when the SLAM module is working properly; and
performing a reset process to reset the plurality of extrinsic parameters until the SLAM module is working properly with the plurality of extrinsic parameters, comprising:
obtaining a first pose of a first camera according to a first image captured by the first camera of the plurality of cameras;
obtaining a second pose of a second camera according to a second image captured by the second camera of the plurality of cameras; and
adjusting a first extrinsic parameters between the first camera and the second camera until a difference between the first pose and the second pose is smaller than a threshold value.

20. The non-transitory computer readable storage medium of claim 15, wherein the parameter calibration method further comprises:
generating the plurality of light spots are generated with a frequency; and
adjusting a plurality of exposures of the plurality of cameras so that the plurality of cameras are able to capture the plurality of images with the plurality of light spots.
